(19) United States
(12) Patent Application Publication
(10) Pub. No.: US 2017/0349361 A1
(43) Pub. Date: Dec. 7, 2017

(54) NOISE-QUIETING COVER FOR WHEELS OF HAND-PORTABLE CONTAINERS

(71) Applicant: Arutyun Balasanyan, North Hollywood, CA (US)

(72) Inventor: Arutyun Balasanyan, North Hollywood, CA (US)

(21) Appl. No.: 15/170,632

(22) Filed: Jun. 1, 2016

(51) Int. Cl. B65D 85/06; B65D 65/02; B65F 1/14; B65F 3/00

(52) U.S. Cl. CPC B65D 85/06; B65F 3/005; B65D 65/02; B65F 1/1473

(57) ABSTRACT

A noise-quieting cover reduces the noise caused by rolling a container with wheels made of plastic or other hard material across a surface. The noise-quieting cover further dampens the vibrations caused by rolling the container across a surface, making transportation of the container more comfortable. The noise-quieting cover has a tread with a thickness to effectively dampen noise and vibration. The cover also has sidewalls with areas large enough to keep the cover in place over the wheel. Grip tabs may also be included which may assist the user in stretching the cover over a wheel, assist in making small adjustments to perfectly place the cover over a wheel, and assist in removing the cover from the wheel.

### FIELD OF THE INVENTION

The present invention generally relates to covers for wheels. More specifically, the present invention is directed to noise-quieting covers for wheels made of plastic, hard rubber, or other material which would otherwise generate loud noise when rolled across the ground, such as the wheels commonly found on the containers issued to residents by city garbage and recycling services.

### BACKGROUND OF THE INVENTION

There are several inventions in the prior art used to mitigate noise produced between a surface and an object having wheels and an axle when the object rolls over the surface. For example, German Patent No. DE 20306012 to Schwarz et al. is directed to a noise absorbing cover attachable to hollow plastic wheels of various kinds of movable toys. The device takes the form of a “coating” comprising a solid tread or rubber mesh cover. The solid tread cover has one sidewall and is designed to be slid over the wheel until the sidewall of the cover hits the sidewall of the wheel. The solid tread cover is designed to fit tightly over a certain type of wheel, such as the wheels of Bobby Cars®. The rubber mesh cover is designed to be stretched over a plastic wheel and is secured to the wheel by elastic bands on either side of the rubber mesh. These toy wheel covers may be used indoors or in an outdoor area such as a street. Because these covers are designed specifically for certain wheels on movable toys, they cannot be adapted for use on refuse or recycling containers. Furthermore, because of the design of the covers, they can only be used on the specific wheel size for which they are made. Refuse and recycling containers have varying wheel sizes and thus it would be advantageous to have one wheel cover that would work on a variety of wheel sizes.

Another reference, Chinese Patent No. CN 201668617 to Keming, is directed to a wheelchair wheel cover attachable to front and rear wheels of a wheelchair for preventing the accumulation of dirt when outside and the generation of noise when rolling across a floor indoors. The wheel covers are strips of elastic fabric with buckling devices on the ends, such as Velcro. To secure a wheel cover around a wheelchair wheel, one must stretch the fabric strip around the wheel and secure the ends by the buckling device. This design would not be ideal for use on refuse, recycling, or other hand-portable containers. These types of containers have much smaller wheels than wheelchair wheels and would require a thicker cover to absorb shock and dampen noise generated from rolling the containers. Because of this, a cover configured as a strip would require a strong buckling device to hold the cover around the wheel which would likely cause a bump in the cover or become loose with repeated rolling.

Additionally, European Patent No. EP 0,730,985, to Delessert et al. is directed to a sound damping panel comprising a sound disc attachable to a motor vehicle wheel rim by peripheral coupling tabs. The disc may comprise a visco-elastic material layer disposed between two metal sheets. The disc is designed to provide for a quiet car interior even under high speed running conditions. Other patents and patent applications disclose similar inventions to reduce the “road noise” heard in the cabin of a vehicle. See U.S. Patent Application Publication No. 2004/0245847 to Hasegawa; British Patent No. GB 2,163,103 to Wolf; and Chinese Patent No. CN 203019726 to Xiaoke et al. This type of shield would not work for refuse, recycling, or other type of hand-portable containers because it is designed to reduce the noise heard inside a container when the problem with the wheels of refuse, recycling, or other type of hand-portable containers is that they generate a lot of noise heard outside of the containers.

U.S. Pat. No. 4,183,572 to Albrecht et al. discloses use of a noise damping screen attachable to an outside surface of a railway wheel for damping wheel noise. U.S. Pat. No. 2,605,132 to Watter and European Patent No. WO 2008/012855 to Cervello disclose similar damping devices for railway wheels. However, this method of damping sound of a wheel would be inconvenient for a refuse or recycling container because it would require a much longer time to install than a cover that is stretched over the wheels.

While there are a number of references in the prior art that disclose devices to mitigate the noise produced by wheels when rolling over a surface, there are no acoustic dampening covers or wraps for attachment to the wheels of utility vessels such as refuse or recycling containers. Refuse and recycling containers, such as those commonly issued by a city's garbage and recycling services, often have a wheel set and axle to transport the container from storage to the side of a street for pick up by a garbage or recycling truck. These wheels are often made of a plastic or other hard material which generates a loud noise when rolled across a driveway or hard surface that is disturbing to the person rolling the container and also to nearby neighbors. Furthermore, when rolled, these hard wheels often create vibrations that travel up the container and to the handles which can cause discomfort to the person moving the container—especially if this person is elderly or suffers from arthritis.

Thus, there exists a significant need for an invention that reduces the noise level and vibrations caused by the wheels of containers such as those commonly found on city issued refuse and recycling containers. Furthermore, it would be desirable to have a noise reducing cover for a wheel that is inexpensive, simple to install, simple to remove, and which fits a range of wheel sizes. The present invention fulfills these needs and provides other related advantages.

The present invention fulfills these needs and provides further related advantages.

### SUMMARY OF THE INVENTION

The present invention comprises a noise-quieting cover which stretches around a wheel of a container, such as the plastic wheels commonly found on city issued refuse and recycling containers. This noise-quieting cover may be comprised of rubber and includes an elastomeric tread forming a hollow cylinder having a first edge and a second edge. The tread is thick enough to effectively quiet the noise produced by rolling the wheel over a surface as well as to dampen the vibrations generated from rolling the wheel. However, the tread is not so thick as to make the cover difficult to stretch over a wheel.

The noise-quieting cover also includes a first sidewall and a second side wall on both sides of the tread which effectively hold the cover in place over the wheel. The first sidewall attaches to the first edge of the tread while the second sidewall attaches to the second edge of the tread. The areas of the first and second sidewall preferably match the areas of the sidewalls of the wheel and are large enough to prevent the cover from slipping out of place when rolled along with the wheel of the container.

The noise-quieting cover includes at least one grip tab that extends off of either the first or second sidewall of the cover, but may include a plurality of grip tabs extending off of the first and second sidewalls of the cover. The grip tabs are located in positions to allow a user to stretch the noise-quieting cover up and down and from side to side. Preferably, the noise-quieting cover includes a plurality of grip tabs on each sidewall where the grip tabs are spaced ninety degrees apart from each other. This spacing is particularly useful when making small adjustments to the cover after it is placed on a wheel.

The relaxed diameter of the tread is slightly smaller than the smallest wheel that is commonly found on refuse and recycling containers. This allows the noise-quieting cover to fit over a range of wheel sizes and to grip the wheels tightly so that the cover does not wrinkle or fold when rolled along with the wheel.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a noise-quieting cover embodying the present invention as it is in position over a plastic wheel of a trash container;

FIG. 2 is a perspective view of the noise-quieting cover of FIG. 1;

FIG. 3 is a side plan view of the noise-quieting cover of FIGS. 1 and 2;

FIG. 4 is an environmental view of a user installing the noise-quieting cover of FIGS. 1-3 over the wheel of a container;

FIG. 5 is a cross-sectional view of the noise-quieting cover of FIGS. 1-4 installed over a wheel of a container; and

FIG. 6 is an environmental view of a user removing the noise-quieting cover of FIGS. 1-5 from a plastic wheel of a container.

### DETAILED DESCRIPTION OF THE PREFERRED EMBODIMENT

As shown in the drawings, the present invention is directed to a noise-quieting cover 10 for wheels. More specifically, the present invention is directed to a noise-quieting cover 10 for the wheels of refuse or recycling containers, such as those often distributed by a city's garbage or recycling services.

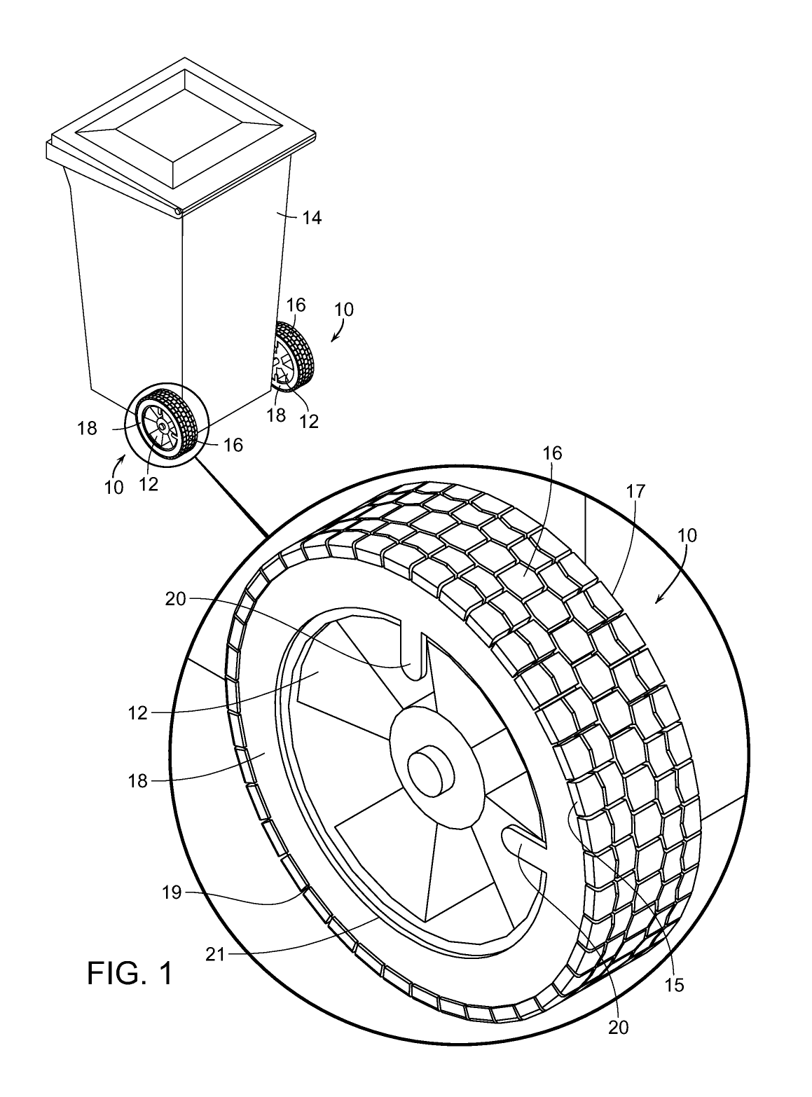

FIG. 1 illustrates a perspective view of the noise-quieting covers 10 installed over the wheels 12 of a container 14. The noise-quieting cover 10 should be made from an elastic rubber or other similar material which does not create a large level of noise when rolled across a hard surface and which also absorbs a majority of the vibration caused by rolling the container over a hard surface. The material should be flexible to allow it to be stretched over a wheel and then to contract back tightly around the wheel. The noise-quieting cover 10 is comprised of a tread 16 in the shape of a hollow cylinder with a first edge 15 and a second edge 17, sidewalls 18 having outer circumferences 19 and inner circumferences 21 where the outer circumferences 19 are attached to the edges 15, 17 of the tread 16, and a plurality of grip tabs 20 protruding from the inner circumferences 21 of the sidewalls 18. When placed over the wheels 12 of a container 14 as shown, the noise-quieting cover 10 reduces the noise created by rolling the container across hard surfaces. Furthermore, the noise-quieting cover 10 reduces the vibrations created from rolling the container across hard surfaces and eliminates the discomfort caused by excessive vibration of the container while rolling.

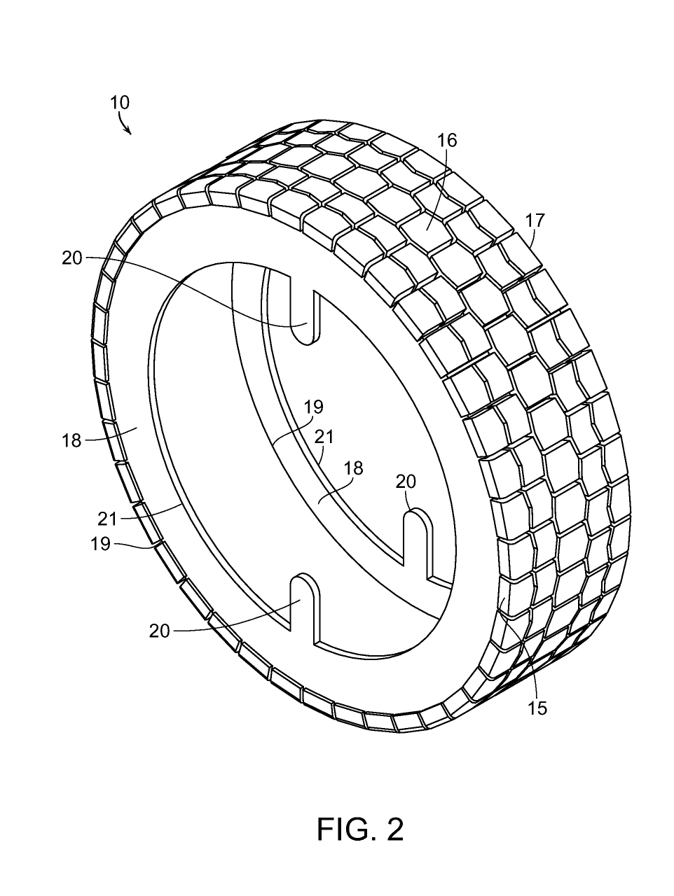

FIG. 2 illustrates a perspective view of the noise-quieting cover 10. The tread 16 should be thick enough to effectively pad the wheels 12 of a container 14 so that the noise from rolling plastic wheels 12 over a driveway will be dampened enough to not cause disturbance to the owner or to neighbors. The thickness should also be great enough to absorb the vibrations caused by rolling the wheels over a hard surface and to stop the vibrations from going up the container 14 and to the handles of the container 14. However, the thickness of the tread 16 should not be so great as to make the noise-quieting cover 10 difficult to stretch over the wheel 12.

The area of the sidewalls 18 of the noise-quieting cover 10 should be large enough to effectively hold the noise-quieting cover 10 in place over the wheel 12. Preferably, the area of the sidewalls 18 of the noise-quieting cover 10 will match the area of the sidewalls of the wheel 12. The grip tabs 20 protrude off of the inner circumferences 21 of the sidewalls 18 and allow the user to better grip and stretch the noise-quieting cover 10.

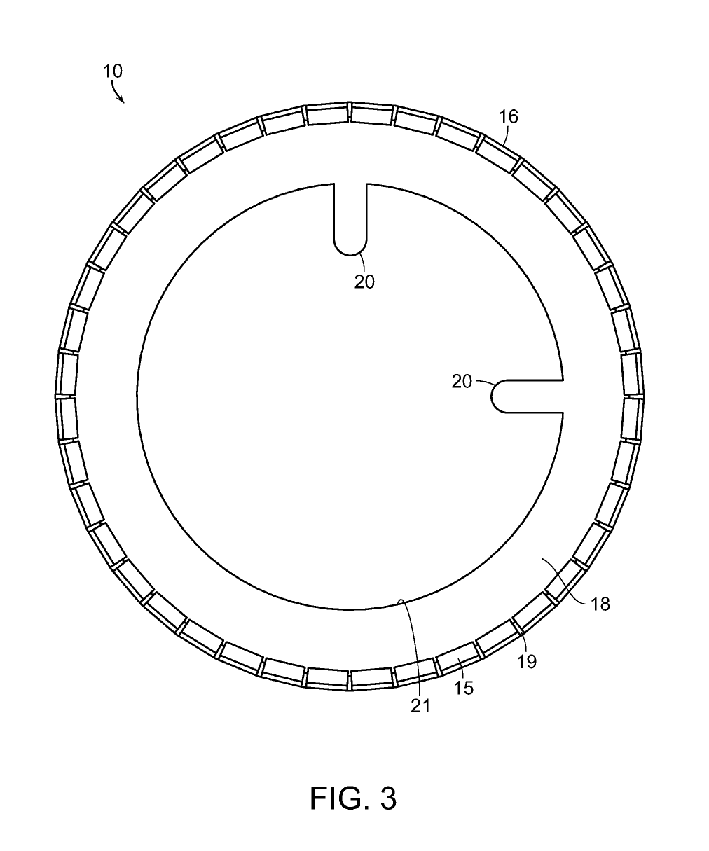

FIG. 3 illustrates a side plan view of the noise-quieting cover 10. This figure illustrates well the diameter of the noise-quieting cover 10 as well as the tread 16, sidewall 18, and grip tabs 20. The noise-quieting cover 10 is preferably comprised of four grip tabs 20, two on both sidewalls 18. The grip tabs 20 should be spaced so as to allow the user to stretch the noise-quieting cover 10 from top to bottom as well as from side to side. Preferably, the grip tabs 20 are spaced ninety degrees apart from each other. The noise-quieting cover 10 should be constructed with a relaxed diameter slightly smaller than the diameter of the smallest wheels 12 to which the noise-quieting cover 10 could be installed. This will allow the noise-quieting cover 10 to be stretched over the wheel 12 and then held securely in place as it is released and grips around the wheel 12. This type of construction is advantageous not only because it holds the noise-quieting cover 10 in place, but also because it allows the noise-quieting cover 10 to be installed to a range of wheel 12 sizes.

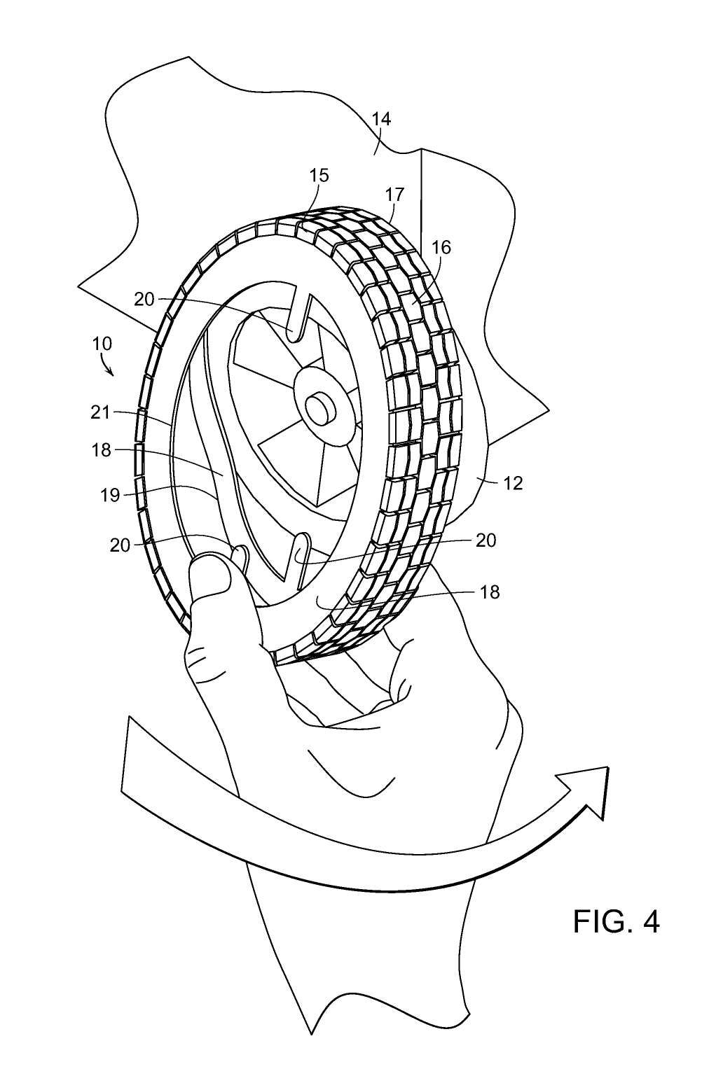

FIG. 4 illustrates an environmental view of the noise-quieting cover 10 being installed by a user over the wheel 12 of a container 14. The figure shows the simplicity of installing the noise-quieting cover 10. The user may attach the noise-quieting cover 10 to the top portion, or any other portion of the wheel 12, and then stretch the noise-quieting cover 10 so that it fits in place around the wheel 12. The user may also incorporate the grip tabs 20 in this process to assist in stretching the cover 10 or to make small adjustments by pulling the noise-quieting cover 10 up and down, or from side to side so that it fits perfectly around the wheel 12.

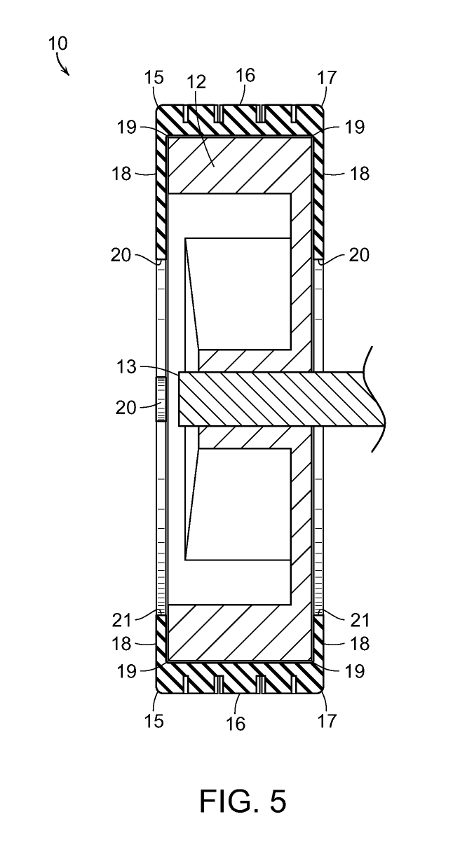

FIG. 5 illustrates a cross-sectional view of the noise-quieting cover 10 as it is installed in place over the wheel 12 and axle 13. The figure shows that when the noise-quieting cover 10 is installed, it fits tightly around the wheel 12 so that the noise-quieting cover 10 will not fold or wrinkle as the wheel 12 rolls across the ground, but rather will stay associated with the wheel and roll smoothly across the ground. The figure also illustrates that the sidewalls 18 are thick enough to keep the noise-quieting cover 10 securely in place around the wheel 12, but not so thick as to make contact with the container 14.

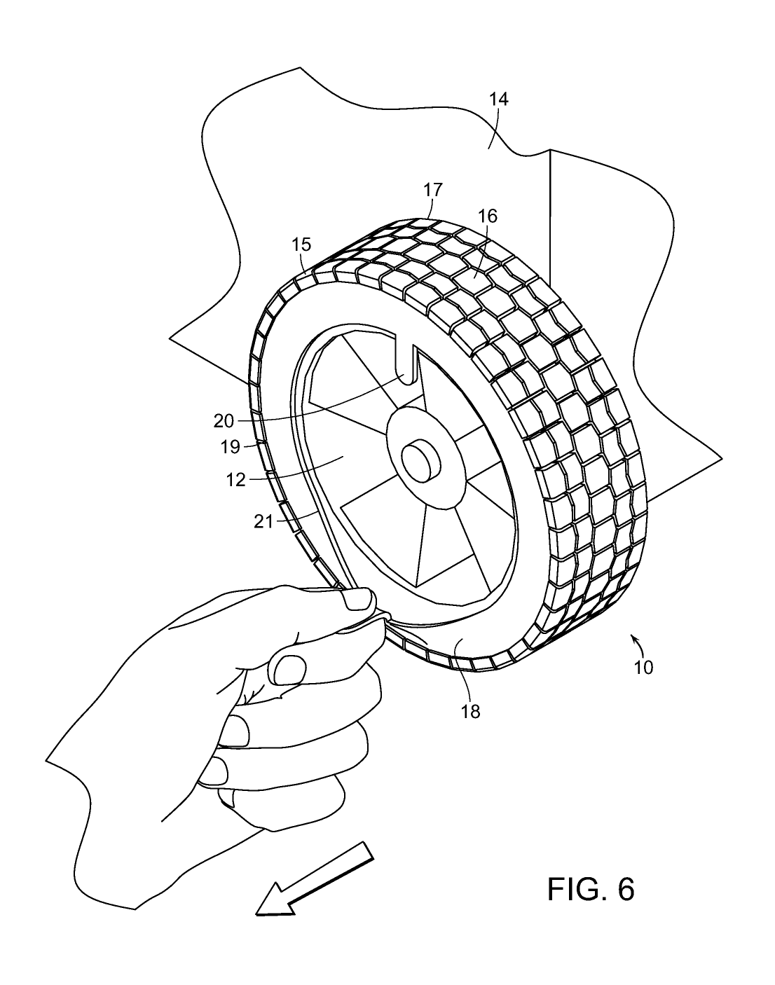

FIG. 6 is an environmental view illustrating the use of the grip tabs 20. As discussed above, the grip tabs 20 may be used to make small adjustments to the noise-quieting cover 10 by pulling the cover 10 up and down or from side to side in order to perfectly place the cover 10 around the wheel. Furthermore, if there is a desire to remove the noise-quieting cover 10, the grip tabs 20 allow the user to quickly pull one portion of the noise-quieting cover 10 off of the wheel 12 so that the cover 10 can be easily removed.

Although one preferred embodiment has been described in detail for purposes of illustration, various modifications may be made without departing from the scope and spirit of the invention. Accordingly, the invention is not to be limited, except as by the appended claims.

What is claimed is:

1. A noise-quieting cover for a wheel of a hand-portable container, comprising:
a tread forming a hollow cylinder and having a first edge and a second edge;
a first sidewall attached to said first edge of said tread;
a second sidewall attached to said second edge of said tread; and
at least one grip tab extending from said first sidewall.

2. The noise-quieting cover of claim 1, wherein at least one grip tab extends from said second sidewall.

3. The noise-quieting cover of claim 1, wherein a plurality of grip tabs extend from said first sidewall.

4. The noise-quieting cover of claim 3, wherein a plurality of grip tabs extend from said second sidewall.

5. The noise-quieting cover of claim 4, wherein said grip tabs extending from said first sidewall are separated by ninety degrees.

6. The noise-quieting cover of claim 5, wherein said grip tabs extending from said second sidewall are separated by ninety degrees.

7. The noise-quieting cover of claim 1, wherein said tread is elastomeric and has a diameter slightly smaller than the diameter of said wheel.

8. The noise-quieting cover of claim 1, wherein said noise-quieting cover comprises rubber.

9. A noise-quieting cover for a wheel of a hand-portable container, comprising:
a tread forming a hollow cylinder and having a first edge and a second edge;
a first sidewall attached to said first edge of said tread;
a second sidewall attached to said second edge of said tread;
a plurality of grip tabs extending from said first sidewall; and
a plurality of grip tabs extending from said second sidewall.

10. The noise-quieting cover of claim 9, wherein said grip tabs extending from said first sidewall are separated by ninety degrees.

11. The noise-quieting cover of claim 10, wherein said grip tabs extending from said second sidewall are separated by ninety degrees.

12. The noise-quieting cover of claim 9, wherein said tread is elastomeric and has a diameter slightly smaller than the diameter of said wheel.

13. The noise-quieting cover of claim 9, wherein said noise-quieting cover comprise rubber.

14. A noise-quieting cover for a wheel of a hand-portable container, comprising:
an elastomeric tread forming a hollow cylinder and having a first edge and a second edge, wherein said tread has a diameter slightly smaller than the diameter of said wheel.
a first sidewall attached to said first edge of said tread;
a second sidewall attached to said second edge of said tread;
a plurality of grip tabs extending from said first sidewall, wherein said plurality of grip tabs are separated by ninety degrees; and
a plurality of grip tabs extending from said second sidewall, wherein said plurality of grip tabs are separated by ninety degrees.

15. The noise-quieting cover of claim 12, wherein said cover comprises rubber.
